(19) United States
(12) Patent Application Publication
(10) Pub. No.: US 2026/0094825 A1
(43) Pub. Date: Apr. 2, 2026

(54) CATHODE FOR LITHIUM SECONDARY BATTERY AND LITHIUM SECONDARY BATTERY INCLUDING THE SAME

(71) Applicant: SK ON CO., LTD., Seoul (KR)

(72) Inventors: Sang Won PARK, Daejeon (KR); Hwan Ho JANG, Daejeon (KR); Seong Cho KWON, Daejeon (KR)

(21) Appl. No.: 19/342,678

(22) Filed: Sep. 29, 2025

(30) Foreign Application Priority Data
Oct. 2, 2024 (KR) 10-2024-0133879
Sep. 16, 2025 (KR) 10-2025-0132420

(51) Int. Cl. H01M 4/525; H01M 4/02; H01M 4/131; H01M 4/36; H01M 4/62; H01M 10/052

(52) U.S. Cl. CPC H01M 4/525; H01M 4/131; H01M 4/366; H01M 4/625; H01M 10/052; H01M 2004/028

(57) ABSTRACT

This disclosure relates to a cathode for a lithium secondary battery and a lithium secondary battery including the same. According to one embodiment of the present disclosure, the cathode for a lithium secondary battery includes: a cathode current collector, and a first cathode active material layer and a second cathode active material layer sequentially stacked on one surface of the cathode current collector. The first cathode active material layer includes a first conductive material and a first cathode active material having a single-particle structure, or a mixture of the first cathode active material and a second cathode active material having a secondary-particle structure, and the second cathode active material layer includes a second conductive material and the second cathode active material, or a mixture of the first cathode active material and the second cathode active material.

### CROSS-REFERENCE TO RELATED APPLICATION

This patent application claims the priority and benefits of Korean patent application No. 10-2024-0133879, filed on Oct. 2, 2024, and Korean patent application No. 10-2025-0132420, filed on Sep. 16, 2025, which are incorporated herein by reference in therein entirety.

### BACKGROUND

### 1. Field of the Invention

The present disclosure relates to a cathode for a lithium secondary battery and a lithium secondary battery including the same.

### 2. Description of the Related Art

Secondary batteries are batteries that can be repeatedly charged and discharged. With the development of information and communication and display industries, they have been widely applied as power sources for portable electronic communication devices, such as camcorders, mobile phones, and laptop PCs. In addition, battery packs including secondary batteries have recently been developed and applied as power sources for eco-friendly vehicles, such as electric cars.

Examples of the secondary battery may include a lithium secondary battery, a nickel-cadmium battery, a nickel-hydrogen battery and the like. Among them, the lithium secondary battery has a high operating voltage and a high energy density per unit weight, making it advantageous in terms of charging speed and lightweight design. In this regard, the lithium secondary battery has been actively developed and applied to various industrial fields.

The lithium secondary battery may include, for example, an electrode assembly including a cathode, an anode and a separation membrane interposed between the cathode and the anode, and an electrolyte that impregnates the electrode assembly.

The cathode may include a cathode current collector and a cathode active material layer formed on the cathode current collector. For example, the cathode active material layer may include a cathode active material, a conductive material, a binder and the like.

During repeated charging and discharging of the lithium secondary battery, the cathode may collapse due to the intercalation and deintercalation of lithium ions into and from the cathode active material. As a result, problems such as gas generation due to side reactions between the lithium metal oxide particles and the electrolyte, and degradation in the cycle life characteristics of the lithium secondary battery may occur. In addition, the above-described problems may be more pronounced during repeated fast charging and discharging.

### SUMMARY

An object of the present disclosure is to provide a cathode for a lithium secondary battery having improved electrochemical properties.

Another object of the present disclosure is to provide a lithium secondary battery including the cathode.

A cathode for a lithium secondary battery according to the present disclosure includes: a cathode current collector, and a first cathode active material layer and a second cathode active material layer sequentially stacked on one surface of the cathode current collector. The first cathode active material layer includes a first conductive material and either a mixture of a first cathode active material having a single-particle structure and a second cathode active material having a secondary-particle structure, or the second cathode active material. The second cathode active material layer includes a second conductive material and either the first cathode active material, or a mixture of the first cathode active material and the second cathode active material. The content of the first cathode active material, based on the total weight of the first cathode active material layer, is less than the content of the second cathode active material. The content of the second cathode active material, based on the total weight of the second cathode active material layer, is less than or equal to the content of the first cathode active material. The content of the first conductive material, based on the total weight of the first cathode active material layer, is less than the content of the second conductive material, based on the total weight of the second cathode active material layer.

In some embodiments, the content of the first cathode active material, based on the total weight of the second cathode active material layer, may be 50% by weight to 99% by weight, and the content of the first cathode active material, based on the total weight of the first cathode active material layer, may be less than 50% by weight.

In some embodiments, the content of the second cathode active material, based on the total weight of the first cathode active material layer, may be 70% by weight to 99% by weight.

In some embodiments, the content of the first cathode active material, based on the total weight of the first cathode active material layer, may be less than 25% by weight.

In some embodiments, the content of the first cathode active material, based on the total weight of the second cathode active material layer, may be 50% by weight to 99% by weight, and the content of the second cathode active material, based on the total weight of the second cathode active material layer, may be less than 50% by weight.

In some embodiments, the content of the first cathode active material, based on the total weight of the second cathode active material layer, may be 70% by weight to 99% by weight.

In some embodiments, the content of the second cathode active material, based on the total weight of the second cathode active material layer, may be less than 25% by weight.

In some embodiments, the content of the first conductive material, based on the total weight of the first cathode active material layer, may be 0.1% by weight to 0.8% by weight.

In some embodiments, the content of the second conductive material, based on the total weight of the second cathode active material layer, may be 0.5% by weight to 1.5% by weight.

In some embodiments, the ratio of the content of the second conductive material, based on the total weight of the second cathode active material layer, to the content of the first conductive material, based on the total weight of the first cathode active material layer, may be greater than 1 and less than or equal to 1.6.

In some embodiments, the first conductive material and the second conductive material may each independently include at least one selected from the group consisting of single-walled carbon nanotubes (SWCNTs), multi-walled carbon nanotubes (MWCNTs), and carbon black.

In some embodiments, the first cathode active material and the second cathode active material may each independently include a lithium metal oxide having a nickel content of 80 mol % to 99 mol % based on the total molar amount of elements excluding lithium and oxygen.

In some embodiments, the first cathode active material and the second cathode active material may be lithium metal oxides having different metal compositions.

In some embodiments, the first cathode active material may include a lithium metal oxide having a nickel content of 80 mol % to 99 mol % based on the total molar amount of elements excluding lithium and oxygen, and the second cathode active material may include a lithium metal oxide having a nickel content different from that of the first cathode active material.

A lithium secondary battery according to the present disclosure includes: the cathode for a lithium secondary battery; and an anode disposed to face the cathode.

The cathode for a lithium secondary battery according to some embodiments of the present disclosure may enable a battery with high capacity retention even during repeated charge and discharge cycles. For example, a battery including the cathode for a lithium secondary battery may exhibit high capacity retention during repeated charge and discharge cycles at room temperature, and in particular, may exhibit improved capacity retention even during fast charge and discharge cycles.

Therefore, a battery with improved cycle life characteristics may be achieved.

The cathode for a lithium secondary battery of the present disclosure and the lithium secondary battery including the same may be widely applied in green technology fields, such as electric vehicles, battery charging stations, as well as solar power generation, wind power generation, and the like, which use the batteries. In addition, the cathode for a lithium secondary battery of the present disclosure and the lithium secondary battery including the same may be used in eco-friendly electric vehicles, hybrid vehicles, and the like, which are aimed at mitigating climate change by reducing air pollution and greenhouse gas emissions.

### BRIEF DESCRIPTION OF THE DRAWINGS

The above and other objects, features and other advantages of the present disclosure will be more clearly understood from the following detailed description taken in conjunction with the accompanying drawings, in which:

FIG. 1 is a schematic cross-sectional view of a cathode for a lithium secondary battery according to an embodiment;

FIG. 2 is a plan view of a lithium secondary battery according to an embodiment;

FIG. 3 is a schematic cross-sectional view of the lithium secondary battery according to an embodiment;

FIG. 4 is a graph showing the capacity retention as a function of the number of cycles at 45° C. for the batteries of the examples and comparative examples;

FIG. 5 is a graph showing the capacity retention as a function of time at 60° C. for the batteries of the examples and Comparative Example 2; and

FIG. 6 is a graph showing the capacity retention as a function of the number of cycles at 25° C. for the batteries of the examples and comparative examples.

### DETAILED DESCRIPTION

A cathode for a lithium secondary battery according to an embodiment of the present disclosure includes a cathode active material layer with a multi-layer structure. In addition, a lithium secondary battery according to an embodiment of the present disclosure includes the cathode.

Hereinafter, exemplary embodiments of the present disclosure will be described in detail with reference to the accompanying drawings. However, these embodiments are merely illustrative, and the present disclosure is not limited to the specific embodiments described as examples.

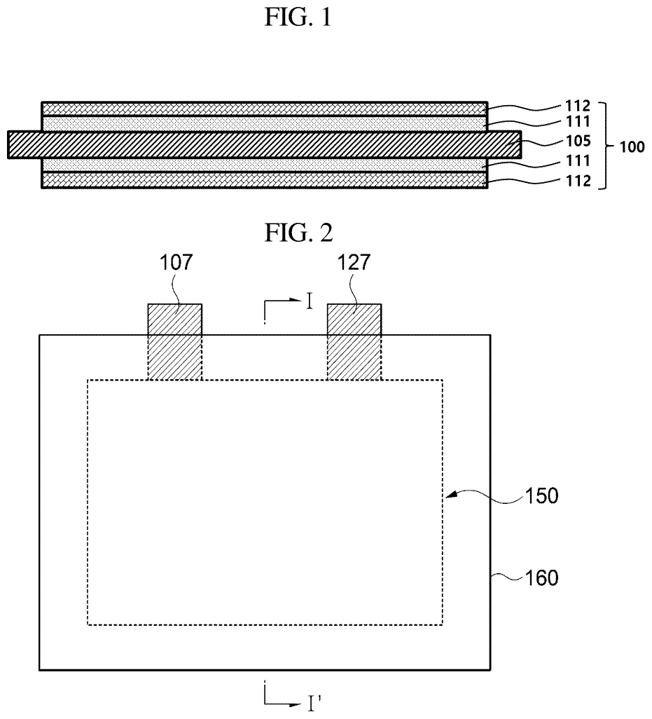

FIG. 1 is a schematic cross-sectional view of a cathode for a lithium secondary battery (hereinafter, also abbreviated as “cathode”) according to an embodiment.

Referring to FIG. 1, a cathode 100 for a lithium secondary battery may include a cathode current collector 105 and a cathode active material layer disposed on at least one surface of the cathode current collector 105. The cathode active material layer may include a first cathode active material layer 111 and a second cathode active material layer 112, and the first cathode active material layer 111 and the second cathode active material layer 112 may be sequentially stacked on at least one surface of the cathode current collector 105.

According to some embodiments, the first cathode active material layer 111 may be formed directly on the surface of the cathode current collector 105. The second cathode active material layer 112 may be formed directly on the upper surface of the first cathode active material layer 111 (e.g., the surface opposite to the contact surface with the cathode current collector).

The first cathode active material layer 111 includes a first conductive material and a mixture of a first cathode active material having a single-particle structure and a second cathode active material having a secondary-particle structure. Alternatively, the first cathode active material layer 111 includes the first conductive material and the second cathode active material.

The second cathode active material layer 112 includes a second conductive material and the first cathode active material. Alternatively, the second cathode active material layer 112 includes the second conductive material and a mixture of the first cathode active material and the second cathode active material.

The first cathode active material may include lithium metal oxide particles having a single-particle structure.

The term “single particle form” as used herein is used, for example, to exclude secondary particles formed by aggregation of a plurality of primary particles. For example, in the first cathode active material, a secondary-particle structure in which (e.g., greater than 10, 20 or more, 30 or more, 40 or more, 50 or more, etc.) of primary particles are assembled or agglomerated may be excluded.

The term “single particle form” as used herein does not exclude a structure in which 2 to 10 single particles are simply attached to or in contact with each other without aggregation to form a monolithic shape.

The second cathode active material may include lithium metal oxide particles having a secondary-particle structure. The term “secondary-particle structure” may refer to a structure distinct from the single-particle structure, in which a single particle includes two or more single crystals.

For example, the single-particle structure and the secondary-particle structure may be identified based on ion images obtained by analyzing a particle cross-section using a focused ion beam (FIB). For example, when the particle has a secondary-particle structure, two or more single particles may be observed in the FIB analysis image due to differences in crystal orientation. For example, even if the particle appears as one particle in a scanning electron microscope (SEM) cross-sectional image, it may be observed as a particle composed of two or more crystals in the FIB analysis image.

In some embodiments, the first cathode active material and the second cathode active material may each independently include a lithium metal oxide. The lithium metal oxide may include nickel, cobalt and/or manganese.

In some embodiments, the first cathode active material and the second cathode active material may each independently include a lithium metal oxide having a nickel content of 80 mol % to 99 mol % based on the total molar amount of elements excluding lithium and oxygen. In some embodiments, the first cathode active material and the second cathode active material may each independently include a lithium metal oxide having a nickel content of 85 mol % to 95 mol % based on the total molar amount of elements excluding lithium and oxygen.

In some embodiments, the lithium metal oxide may include a layered structure represented by Formula 1 below.

LiₓNi_{(1-a-b)}CoₐM_{b}O_{y} [Formula 1]

For example, in Formula 1, M may be at least one of Al, Zr, Ti, Cr, B, Mg, Mn, Ba, Si, Y, W and Sr, and x, y, a and b may satisfy 0.9≤x≤1.2, 1.9≤y≤2.1, 0≤a+b≤0.5.

In some embodiments, a+b may satisfy 0<a+b≤0.4, 0<a+b≤0.3, 0<a+b≤0.2, 0<a+b≤0.17, 0<a+b≤0.15, 0<a+b≤0.12, or 0<a+b≤0.1.

In some embodiments, a may be in the range of 0<a≤0.1, 0<a≤0.08, or 0<a≤0.05.

As indicated in Formula 1, the lithium metal compound may include Ni among Ni, Co and M in the greatest amount or molar ratio. Ni may function as a metal substantially related to the output and/or capacity of the lithium secondary battery, and by including Ni in the greatest amount among transition metals, a high-capacity, high-output lithium secondary battery may be achieved.

When the content of Ni in the cathode active material or lithium metal oxide increases, the chemical stability such as the high-temperature storage stability of the secondary battery, may be relatively degraded. In addition, sufficient high-output and high-capacity characteristics resulting from the high Ni content may not be achieved due to surface damage on the cathode active material or side reactions with the electrolyte during repeated charge and discharge cycles.

In one embodiment, the lithium metal oxide particles may further include a coating element or a doping element. For example, the coating element or doping element may include Al, Ti, Ba, Zr, Si, B, Mg, P, Sr, W, La or an alloy or oxide thereof. In this case, a lithium secondary battery with improved cycle life characteristics may be achieved.

The first cathode active material and the second cathode active material may be lithium metal oxides having different metal compositions. For example, the first cathode active material may include a lithium metal oxide having a nickel content of 80 mol % to 99 mol % based on the total molar amount of elements excluding lithium and oxygen, and the second cathode active material may include a lithium metal oxide having a nickel content different from that of the first cathode active material.

The content of the first cathode active material, based on the total weight of the first cathode active material layer 111, may be less than that of the second cathode active material. For example, the first cathode active material layer 111 may include no first cathode active material, or when it does include the first cathode active material, the content of the first cathode active material may be less than that of the second cathode active material.

The first cathode active material layer 111, which is adjacent to the cathode current collector 105 and to which electrons reach first during repeated battery charge and discharge cycles, may include a higher content of the second cathode active material than that of the first cathode active material. This reduces gas generation due to internal cracking.

In some embodiments, the content of the first cathode active material, based on the total weight of the first cathode active material layer, may be less than 50 wt %. In some embodiments, the content of the first cathode active material, based on the total weight of the first cathode active material layer, may be less than 25 wt %, or may be 24.60 wt % or less, or may be 24.56 wt % or less.

In some embodiments, the content of the second cathode active material, based on the total weight of the first cathode active material layer, may be 50 wt % to 99 wt %. In some embodiments, the content of the second cathode active material, based on the total weight of the first cathode active material layer, may be 70 wt % to 99 wt %. Alternatively, the content may be 98.40 wt % or less, 73.80 wt % or less, or 73.67 wt % or less.

Within the above range, a cathode with further improved cycle life characteristics may be achieved.

In some embodiments, the content of the second cathode active material, based on the total weight of the second cathode active material layer 112, may be less than or equal to that of the first cathode active material. For example, the second cathode active material layer 112 may include no second cathode active material, and when it does include the second cathode active material, the content of the second cathode active material may be less than or equal to that of the first cathode active material.

The first cathode active material having a single-particle structure has a smaller particle size than the second cathode active material, resulting in less particle cracking during roll-pressing. The second cathode active material layer 112, which is spaced apart from the cathode current collector 105 and first contacts the electrolyte, may include a higher content of the first cathode active material than that of the second cathode active material. This may increase reactivity and reduce gas generation rates.

In some embodiments, the content of the first cathode active material, based on the total weight of the second cathode active material layer, may be 50 wt % to 99 wt %. In some embodiments, the content of the first cathode active material, based on the total weight of the second cathode active material layer, may be 70 wt % to 99 wt %. Alternatively, the content may be 98.16 wt % or less, 73.62 wt % or less, or 73.49 wt % or less.

In some embodiments, the content of the second cathode active material, based on the total weight of the second cathode active material layer, may be less than 50 wt %. In some embodiments, the content of the second cathode active material, based on the total weight of the second cathode active material layer, may be 25 wt % or less, 24.54 wt % or less, or 24.50 wt % or less.

Within the above range, a cathode with further improved cycle life characteristics may be achieved.

The content of the first conductive material, based on the total weight of the first cathode active material layer 111, may be less than that of the second conductive material, based on the total weight of the second cathode active material layer 112. Accordingly, the electrical conductivity of the second cathode active material layer 112 may be further enhanced, and the fast charge and discharge characteristics of the battery may be improved.

When the content of the first conductive material, based on the total weight of the first cathode active material layer 111, is greater than that of the second conductive material, based on the total weight of the second cathode active material layer 112, the electrical conductivity of the second cathode active material layer 112 spaced apart from the cathode current collector 105 may be reduced. As a result, the charge and discharge rate of the battery may decrease, and accordingly, the cycle life characteristics of the battery during repeated fast charging and discharging may be significantly reduced.

In some embodiments, the content of the first conductive material, based on the total weight of the first cathode active material layer, may be 0.1 wt % to 0.8 wt %. In some embodiments, the content of the first conductive material, based on the total weight of the first cathode active material layer, may be 0.2 wt % to 0.75 wt %, or 0.3 wt % to 0.7 wt %. Alternatively, the content of the first conductive material may be 0.4 wt % or more, 0.5 wt % or more, 0.6 wt % or more, or 0.7 wt % or less, 0.6 wt % or less, 0.5 wt % or less, or 0.4 wt % or less.

In some embodiments, the content of the second conductive material, based on the total weight of the second cathode active material layer, may be 0.5 wt % to 1.5 wt %. In some embodiments, the content of the second conductive material, based on the total weight of the second cathode active material layer, may be 0.55 wt % to 1 wt %, or 0.6 wt % to 0.9 wt %. Alternatively, the content of the second conductive material may be 0.5 wt % or more, 0.6 wt % or more, 0.7 wt % or more, or 0.9 wt % or less, 0.7 wt % or less, 0.6 wt % or less, or 0.5 wt % or less.

Within the above range, the electrical conductivity of the first cathode active material layer 111 may be sufficiently secured while further improving the electrical conductivity of the second cathode active material layer 112, thereby enhancing the fast charge and discharge cycle life characteristics of the battery.

In some embodiments, the ratio of the content of the second conductive material, based on the total weight of the second cathode active material layer, to that of the first conductive material, based on the total weight of the first cathode active material layer, may be greater than 1 and less than or equal to 1.6. In some embodiments, the ratio of the content of the second conductive material, based on the total weight of the second cathode active material layer, to that of the first conductive material, based on the total weight of the first cathode active material layer, may be 1.2 to 1.5.

Within the above range, the fast charge and discharge cycle life characteristics of the battery may be further improved.

In some embodiments, the first conductive material and the second conductive material may each independently include single-walled carbon nanotubes (SWCNTs), multi-walled carbon nanotubes (MWCNTs), carbon black and the like. In some embodiments, the first conductive material and the second conductive material may include a CNT-based conductive material including single-walled carbon nanotubes (SWCNTs), multi-walled carbon nanotubes (MWCNTs), and the like, and a non-CNT-carbon-based conductive material including carbon black and the like.

In some embodiments, the content of the CNT-based conductive material, based on the total weight of the first conductive material, may be greater than that of the non-CNT-carbon-based conductive material, and the content of the CNT-based conductive material, based on the total weight of the second conductive material, may be greater than that of the non-CNT-carbon-based conductive material.

According to some embodiments, the first cathode active material layer 111 and the second cathode active material layer 112 may each be formed by applying a cathode slurry including the first cathode active material and/or the second cathode active material and the first conductive material or the second conductive material to the surface of the cathode current collector, followed by drying and compressing.

For example, the first cathode active material and/or the second cathode active material and the conductive material may each be mixed and stirred with a binder and/or a dispersant in a solvent to prepare a first cathode slurry and a second cathode slurry, respectively. The first cathode slurry may be coated onto the cathode current collector 105, and then dried and roll-pressed to form the first cathode active material layer 111, while the second cathode slurry may be coated onto the first cathode active material layer 111, and then dried and roll-pressed to form the second cathode active material layer 112.

The cathode current collector 105 may include, for example, stainless steel, nickel, aluminum, titanium, copper, or an alloy thereof, and alternately, may include aluminum or an aluminum alloy.

The binder may include, for example, an organic binder such as vinylidene fluoride-hexafluoropropylene copolymer (PVDF-co-HFP), polyvinylidene fluoride (PVDF), polyacrylonitrile, polymethyl methacrylate, etc., or an aqueous binder such as styrene-butadiene rubber (SBR), and may be used together with a thickener such as carboxymethyl cellulose (CMC).

For example, a PVDF-based binder may be used as the cathode binder. In this case, an amount of the binder for forming the cathode active material layer may be reduced and an amount of the cathode active material may be relatively increased, thereby improving the output and capacity of the secondary battery.

The thicknesses of the first cathode active material layer 111 and the second cathode active material layer 112 are not particularly limited and, for example, may be the same.

A lithium secondary battery according to the present disclosure includes the cathode for a lithium secondary battery and an anode disposed to face the cathode.

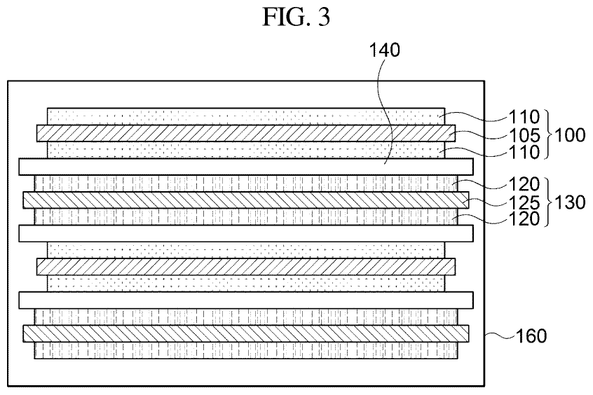

Hereinafter, the lithium secondary battery according to exemplary embodiments will be described in more detail with reference to the drawings. FIGS. 2 and 3 are schematic plan and cross-sectional views illustrating the lithium secondary battery according to exemplary embodiments, respectively. For example, FIG. 3 is a cross-sectional view taken along the line I-I′ of FIG. 2 in the thickness direction.

Referring to FIGS. 2 and 3, the lithium secondary battery may include an electrode assembly including the cathode 100, the anode 130, and a separation membrane 140 interposed between the cathode and the anode. The electrode assembly may be accommodated in a case 160 together with an electrolyte and may be impregnated with the electrolyte.

The cathode 100 includes the cathode current collector 105 and the cathode active material layer 110, wherein the cathode active material layer 110 includes a first cathode active material layer and a second cathode active material layer (not shown). The cathode 100 may be the same as described above.

In some embodiments, the anode 130 may include an anode current collector 125 and an anode active material layer 120 disposed on one surface of the anode current collector 125. The anode active material layer 120 may include a silicon-based active material, natural graphite, or artificial graphite.

The anode current collector 125 may include, for example, stainless steel, nickel, aluminum, titanium, copper, or an alloy thereof, and in some embodiments, may include copper or an alloy thereof.

The silicon-based active material may include, for example, a silicon-carbon composite compound such as silicon, silicon oxide (SiOx, 0<x<2), or silicon carbide (SIC).

In some embodiments, the content of the silicon-based active material, based on the total weight of the anode active material layer, may be 1 wt % to 15 wt %. In some embodiments, the content of the silicon-based active material, based on the total weight of the anode active material layer, may be 2 wt % to 10 wt %.

In some embodiments, the anode may have a crystal orientation index of 1 to 10, as defined by Equation 1 below. In some embodiments, the anode may have a crystal orientation index of 2 to 7, as defined by Equation 1 below.

OI=I₀₀₄/I₁₁₀ [Equation 1]

In Equation 1, OI represents the crystal orientation index, O₀₀₄ represents the peak intensity of the (004) plane in the X-ray diffraction (XRD) pattern of the anode, and I₁₁₀ represents the peak intensity of the (110) plane in the XRD pattern of the anode.

The X-ray diffraction analysis may be performed using the equipment and under the conditions described below.
XRD (X-Ray Diffractometer) EMPYREAN
Maker: PANalytical
Anode material: Cu
K-Alpha1 wavelength: 1.540598 Å
Generator voltage: 45 kV
Tube current: 40 mA
Scan range: 10-120°
Scan step size: 0.0065°
Divergence slit: ¼°
Antiscatter slit: ½°

An XRD pattern may be obtained from the results of the XRD analysis. In the obtained XRD pattern, a peak corresponding to the (004) plane and a peak corresponding to the (110) plane may be observed. The intensity ratio of the two peaks may be calculated according to Equation 1 above, and the artificial graphite within the anode active material layer of an anode having a crystal orientation index of 1 to 10, as defined by Equation 1, may have an appropriate degree of orientation.

For example, as the crystal orientation index increases, the (004) plane of the artificial graphite may be oriented closer to the horizontal direction with respect to the electrode current collector, and the (110) plane may be oriented closer to the vertical direction with respect to the surface of the electrode current collector.

When the crystal orientation index falls within the above range, the artificial graphite within the anode active material layer may be oriented in a direction that facilitates lithium-ion intercalation and deintercalation, thereby reducing lithium-ion diffusion resistance. In addition, the formation of dendrites caused by lithium precipitation during high-rate charging and discharging may be suppressed, thereby improving the thermal stability and cycle life characteristics of the battery. Furthermore, the occurrence of internal short circuits in the battery may be suppressed, thereby reducing the risk of fire, explosion and the like.

In some embodiments, the anode active material layer 120 may include a first anode active material layer and a second anode active material layer. The first anode active material layer and the second anode active material layer may be sequentially stacked on one surface of the anode current collector 125.

The first anode active material layer and the second anode active material layer may each independently include a silicon-based active material, artificial graphite, and natural graphite.

The content of the silicon-based active material, based on the total weight of the first anode active material layer, may be less than that of the silicon-based active material based on the total weight of the second anode active material layer.

In some embodiments, the content of the silicon-based active material, based on the total weight of the first anode active material layer, may be 0.5 wt % to 5 wt %, and the content of the silicon-based active material, based on the total weight of the second anode active material layer, may be 7 wt % to 15 wt %.

Within the above range, the second anode active material layer, which is spaced apart from the anode current collector 125, may include a higher content of silicon-based active material having a high volume change rate during charge and discharge. Accordingly, the stability of the anode during battery charge and discharge may be improved, and the cycle life characteristics of the battery may be enhanced. In some embodiments, the content of the artificial graphite, based on the total weight of the first anode active material layer, may be less than that of the artificial graphite based on the total weight of the second anode active material layer. For example, the content of the artificial graphite, based on the total weight of the first anode active material layer, may be 20 wt % to 50 wt %, and the content of the artificial graphite, based on the total weight of the second anode active material layer, may be 55 wt % to 75 wt %.

In some embodiments, the content of the natural graphite, based on the total weight of the first anode active material layer, may be greater than that of the natural graphite based on the total weight of the second anode active material layer. For example, the content of the natural graphite, based on the total weight of the first anode active material layer, may be 55 wt % to 75 wt %, and the content of the natural graphite, based on the total weight of the second anode active material layer, may be 20 wt % to 50 wt %.

Within the above range, the stability of the anode may be further improved, and the cycle life characteristics of the battery may be further enhanced.

The anode 130 may include the anode active material layer 120 formed by coating an anode slurry onto the anode current collector 125. The anode slurry may include a silicon-based active material, artificial graphite, natural graphite, an anode binder and a conductive material.

The anode slurry may be prepared by mixing and stirring the anode active material with a binder, a conductive material and/or a dispersant in a solvent. The slurry may be coated onto the anode current collector 125, and then dried and roll-pressed to prepare the anode active material layer 120.

For example, the anode slurry may be prepared by mixing the anode active material with a solvent. The anode slurry may be applied onto one surface of the anode current collector, followed by drying and roll-pressing to prepare the anode active material layer 120.

The coating process may be performed by any method such as gravure coating, slot die coating, simultaneous multilayer die coating, imprinting, doctor blade coating, dip coating, bar coating, casting, or the like, but is not limited thereto. The anode active material layer 120 may further include a binder and may optionally further include a conductive material, a thickener or the like.

Non-limiting examples of the solvent may include water, pure water, deionized water, distilled water, ethanol, isopropanol, methanol, acetone, n-propanol, t-butanol, etc.

The above-described materials that can be used when manufacturing the cathode as the binder, conductive material and thickener may also be used for the anode.

In some embodiments, a styrene-butadiene rubber (SBR)-based binder, carboxymethyl cellulose (CMC), polyacrylic acid-based binder, poly(3,4-ethylenedioxythiophene) (PEDOT)-based binder, and the like may be used as an anode binder.

In addition, the anode slurry may further include a dispersant for a conductive material to improve the dispersibility of the conductive material. For example, the dispersant for a conductive material may include N-methyl pyrrolidone.

The separation membrane 140 may be interposed between the cathode 100 and the anode 130. The separation membrane 140 may include a porous polymer film made of a polyolefin polymer such as ethylene homopolymer, propylene homopolymer, ethylene/butene copolymer, ethylene/hexene copolymer, ethylene/methacrylate copolymer. The separation membrane 140 may include a nonwoven fabric made of glass fibers having a high melting point, polyethylene terephthalate fibers, etc.

In some embodiments, the anode 130 may have an area (e.g., a contact area with the separation membrane 140) and/or volume larger than those of the cathode 100. Thereby, lithium ions generated from the cathode 100 may smoothly migrate to the anode 130 without being precipitated during the process, for example.

According to some embodiments, an electrode cell is defined by the cathode 100, the anode 130 and the separation membrane 140, and a plurality of electrode cells may be stacked to form, for example, a jelly roll type electrode assembly 150. For example, the electrode assembly 150 may be formed by winding, stacking, or folding like the separation membrane 140.

The electrode assembly 150 may be accommodated in the case 160 together with the electrolyte to define the lithium secondary battery. According to some embodiments, the lithium secondary battery may use a non-aqueous electrolyte.

The non-aqueous electrolyte may include a lithium salt of an electrolyte and an organic solvent, the lithium salt is represented by, for example, Li⁺X⁻; and as an anion (X⁻) of the lithium salt, F⁻, Cl⁻, Br⁻, I⁻, NO₃⁻; N(CN)₂⁻, BF₄⁻, ClO₄⁻, PF₆⁻, (CF₃)₂PF₄⁻, (CF₃)₃PF₃⁻, (CF₃)₄PF₂⁻, (CF₃)₅PF⁻, (CF₃)₆P⁻, CF₃SO₃⁻; CF₃CF₂SO₃⁻, (CF₃SO₂)N⁻, (FSO₂)₂N⁻; CF₃CF₂(CF₃)₂CO⁻, (CF₃SO₂)₂CH⁻, (SF₅)₃C⁻, (CF₃SO₂)₃C⁻, CF₃(CF₂)₇SO₃⁻, CF₃CO₂⁻, CH₃CO₂⁻, SCN⁻ and (CF₃CF₂SO₂)₂N⁻, etc. may be exemplified.

As the organic solvent, for example, propylene carbonate (PC), ethylene carbonate (EC), diethyl carbonate (DEC), dimethyl carbonate (DMC), ethyl methyl carbonate (EMC), methyl propyl carbonate, dipropyl carbonate, dimethyl sulfoxide, acetonitrile, dimethoxyethane, diethoxyethane, vinylene carbonate, sulfolane, γ-butyrolactone, propylene sulfite, tetrahydrofuran, and the like may be used. These compounds may be used alone or in combination of two or more thereof.

As shown in FIG. 2, electrode tabs (cathode tabs and anode tabs) may be formed from the cathode current collector 105 and the anode current collector 125, each belonging to a respective electrode cell, and may extend to one side of the case 160. The electrode tabs may be welded together with the one side of the case 160 to form electrode leads (a cathode lead 107 and an anode lead 127) that extend from or are exposed to the outside of the case 160.

The lithium secondary battery may be manufactured, for example, in a cylindrical shape using a can, a prismatic shape, a pouch shape or a coin shape.

Hereinafter, embodiments of the present disclosure will be further described with reference to specific experimental examples. However, the examples and comparative examples included in the experimental examples are provided merely for illustrative purposes of the present disclosure and are not intended to limit the scope of the appended claims. It will be apparent to those skilled in the art that various changes and modifications can be made within the scope and spirit of the present disclosure, and such changes and modifications are to be regarded as falling within the scope of the appended claims.

### Example 1

### (1) Preparation of Cathode

A lithium metal oxide having a secondary-particle structure represented by LiNi_{0.88}CO_{0.06}Mn_{0.06}O₂ (D50=13 μm), a binder (PVdF), a conductive material (multi-walled carbon nanotubes; MWCNTs), and a dispersant for a conductive material (N-methyl pyrrolidone; NMP) were mixed in a mass ratio of 98.40:1:0.5:0.1, and then mixed with water as a solvent to prepare a first cathode slurry.

A lithium metal oxide having a single-particle structure represented by LiNi_{0.88}Co_{0.6}Mn_{0.6}O₂ (D50=3-4 μm), polyvinylidene fluoride (PVdF) as a binder, multi-walled carbon nanotubes (MWCNTs) as a conductive material, and a dispersant for a conductive material (NMP) were mixed in a mass ratio of 98.16:1:0.7:0.14, and then mixed with water as a solvent to prepare a second cathode slurry.

The first cathode slurry was uniformly applied to an aluminum foil (thickness: 12 μm), and then dried and roll-pressed to form a first cathode active material layer.

The second cathode slurry was uniformly applied to the first cathode active material layer, and then dried and roll-pressed to form a second cathode active material layer.

The total loading amounts of the first cathode active material layer and the second cathode active material layer were 21.30 g/cm², and the electrode density was 3.7 g/cm³.

### (2) Manufacture of Battery

Natural graphite, artificial graphite, and SiOx (0<x<2) as anode active materials, styrene-butadiene rubber as a binder, carboxymethyl cellulose as a thickener, single-walled carbon nanotubes (SWCNTs) as conductive materials, and a dispersant for a conductive material (NMP) were mixed in a mass ratio of 44.55:44.55:8.00:1.50:1.20:0.08:0.12 and then dispersed in water to prepare an anode slurry. The anode slurry was coated on a copper foil having a thickness of 8 μm, and then dried and roll-pressed to fabricate an anode. The loading amount of the anode active material layer was 10.60 g/cm², and the electrode density was 1.64 g/cm³.

A film separator made of polyethylene (PE) with a thickness of 13 μm was stacked between the fabricated anode and the cathode, and a cell was assembled using a pouch having dimensions of 5 mm (thickness)×50 mm (width)×60 mm (length). Then, the non-aqueous electrolyte was injected into the pouch to manufacture a 2 Ah-class lithium secondary battery for an electric vehicle (EV). As the non-aqueous electrolyte, a solution in which LiPF₆ was dissolved at a concentration of 1 M in a mixed solvent containing ethylene carbonate and ethyl methyl carbonate in a volume ratio of 25:75 was used.

### Example 2

A lithium metal oxide having a single-particle structure (D50=3-4 μm) represented by LiNi_{0.88}Co_{0.06}Mn_{0.06}O₂, a lithium metal oxide having a secondary-particle structure (D50=13 μm) represented by LiNi_{0.88}Co_{0.06}Mn_{0.06}O₂, a binder (PVdF), a conductive material (multi-walled carbon nanotubes; MWCNTs), and a dispersant for a conductive material (NMP) were mixed in a mass ratio of 24.60:73.80:1:0.5:0.1, and then mixed with water as a solvent to prepare a first cathode slurry.

A lithium metal oxide having a single-particle structure (D50=3-4 μm) represented by LiNi_{0.88}Co_{0.06}Mn_{0.06}O₂, a lithium metal oxide having a secondary-particle structure (D50=13 μm) represented by LiNi_{0.88}Co_{0.06}Mn_{0.06}O₂, polyvinylidene fluoride (PVdF) as a binder, multi-walled carbon nanotubes (MWCNTs) as a conductive material, and a dispersant for a conductive material (NMP) were mixed in a mass ratio of 73.62:24.54:1:0.7:0.14, and then mixed with water as a solvent to prepare a second cathode slurry.

A cathode and a battery were manufactured in the same manner as in Example 1, except that the first cathode slurry and the second cathode slurry were prepared as described above.

### Example 3

A lithium metal oxide having a single-particle structure (D50=3-4 μm) represented by LiNi_{0.88}Co_{0.06}Mn_{0.06}O₂, a lithium metal oxide having a secondary-particle structure (D50=13 μm) represented by LiNi_{0.88}Co_{0.06}Mn_{0.06}O₂, polyvinylidene fluoride (PVdF) as a binder, multi-walled carbon nanotubes (MWCNTs) and carbon black as conductive materials, and a dispersant for a conductive material (NMP) were mixed in a mass ratio of 24.56:73.66:1:0.4:0.30:0.08, and then mixed with water as a solvent to prepare a first cathode slurry.

A single-particle lithium metal oxide (D50=3-4 μm) represented by LiNi_{0.88}Co_{0.06}Mn_{0.06}O₂, a secondary particle lithium metal oxide (D50=13 μm) represented by LiNi_{0.88}Co_{0.06}Mn_{0.06}O₂, polyvinylidene fluoride (PVdF) as a binder, multi-walled carbon nanotubes (MWCNTs) and carbon black as conductive materials, and a dispersant for a conductive material (NMP) were mixed in a mass ratio of 73.48:24.50:1:0.6:0.30:0.12, and then mixed with water as a solvent to prepare a second cathode slurry.

A cathode and a battery were manufactured in the same manner as in Example 1, except that the first cathode slurry and the second cathode slurry were prepared as described above.

### Comparative Example 1

A lithium metal oxide having a secondary-particle structure (D50=13 μm) represented by LiNi_{0.88}Co_{0.06}Mn_{0.06}O₂, a binder (PVdF), a conductive material (multi-walled carbon nanotubes; MWCNTs), and a dispersant for a conductive material (NMP) were mixed at a mass ratio of 98.16:1:0.7:0.14, and then mixed with water as a solvent to prepare a first cathode slurry.

A lithium metal oxide having a single-particle structure represented by LiNi_{0.88}Co_{0.06}Mn_{0.06}O₂ (D50=3-4 μm), a binder of polyvinylidene fluoride (PVdF), a conductive material of multi-walled carbon nanotubes (MWCNTs), and a dispersant for a conductive material (NMP) were mixed at a mass ratio of 98.40:1:0.5:0.1, and then mixed with water as a solvent to prepare a second cathode slurry.

A cathode and a battery were manufactured in the same manner as in Example 1, except that the first cathode slurry and the second cathode slurry were prepared as described above.

### Comparative Example 2

A cathode and a battery were manufactured in the same manner as in Example 1, except that a lithium metal oxide having a single-particle structure represented by LiNi_{0.88}Co_{0.06}Mn_{0.06}O₂ (D50=3-4 μm) was used instead of the secondary-particle lithium metal oxide during the preparation of the first cathode slurry.

### Comparative Example 3

A lithium metal oxide having a secondary-particle structure represented by LiNi_{0.88}Co_{0.06}Mn_{0.06}O₂ (D50=13 μm), polyvinylidene fluoride (PVdF) as a binder, multi-walled carbon nanotubes (MWCNTs) as a conductive material, and a dispersant for a conductive material (NMP) were mixed in a mass ratio of 98.28:1:0.6:0.12, and then mixed with water as a solvent to prepare a first cathode slurry.

A lithium metal oxide having a single-particle structure represented by LiNi_{0.88}Co_{0.06}Mn_{0.06}O₂ (D50=3-4 μm), a binder (PVdF), a conductive material (multi-walled carbon nanotubes; MWCNTs), and a dispersant for a conductive material (NMP) were mixed in a mass ratio of 98.28:1:0.6:0.12, and then mixed with water as a solvent to prepare a second cathode slurry.

A cathode and a battery were manufactured in the same manner as in Example 1, except that the first cathode slurry and the second cathode slurry were prepared as described above.

The compositions of the cathodes of the examples and comparative examples are shown in Table 1 below.

TABLE 1

| | | | | | Conductive | | Dispersant for | |
|---|---|---|---|---|---|---|---|---|
| | | | Single | Secondary | material | | conductive | |
| | | | particle | particle | C-1 | C-2 | material | Binder |
| Example | 1 | Second layer | 98.16 | — | 0.70 | — | 0.14 | 1 |
| | | First layer | — | 98.40 | 0.50 | — | 0.10 | 1 |
| | | Total | 49.08 | 49.20 | 0.60 | — | 0.12 | 1 |
| | 2 | Second layer | 73.62 | 24.54 | 0.70 | — | 0.14 | 1 |
| | | First layer | 24.60 | 73.80 | 0.50 | — | 0.10 | 1 |
| | | Average | 49.11 | 49.17 | 0.60 | — | 0.12 | 1 |
| | 3 | Second layer | 73.48 | 24.50 | 0.60 | 0.30 | 0.12 | 1 |
| | | First layer | 24.56 | 73.66 | 0.40 | 0.30 | 0.08 | 1 |
| | | Average | 49.02 | 49.08 | 0.50 | 0.30 | 0.10 | 1 |
| Comparative | 1 | Second layer | 98.40 | — | 0.50 | — | 0.10 | 1 |
| Example | | First layer | — | 98.16 | 0.70 | — | 0.14 | 1 |
| | | Average | 49.20 | 49.08 | 0.60 | — | 0.12 | 1 |
| | 2 | Second layer | — | 98.16 | 0.70 | — | 0.14 | 1 |
| | | First layer | — | 98.40 | 0.50 | — | 0.10 | 1 |
| | | Average | — | 98.28 | 0.60 | — | 0.12 | 1 |
| | 3 | Second layer | 98.28 | — | 0.60 | — | 0.12 | 1 |
| | | First layer | — | 98.28 | 0.60 | — | 0.12 | 1 |
| | | Average | 49.14 | 49.14 | 0.60 | — | 0.12 | 1 |

C-1: Multi-walled carbon nanotubes (MWCNTs)
C-2: Carbon black

### Experimental Example 1: Evaluation of High-Temperature Cycle Life Characteristics

The lithium secondary batteries of the examples and comparative examples were subjected to repeated charging (CC-CV 0.3C 4.2V 0.05C cut-off) to SOC 96% and discharging (0.3C constant current, 2.6V cut-off) to SOC 2% for 1,000 cycles. The discharge capacity was measured according to the number of cycles, and the capacity retention was calculated by dividing the discharge capacities at the 800th, 900th and 1,000th cycles by the initial discharge capacity.

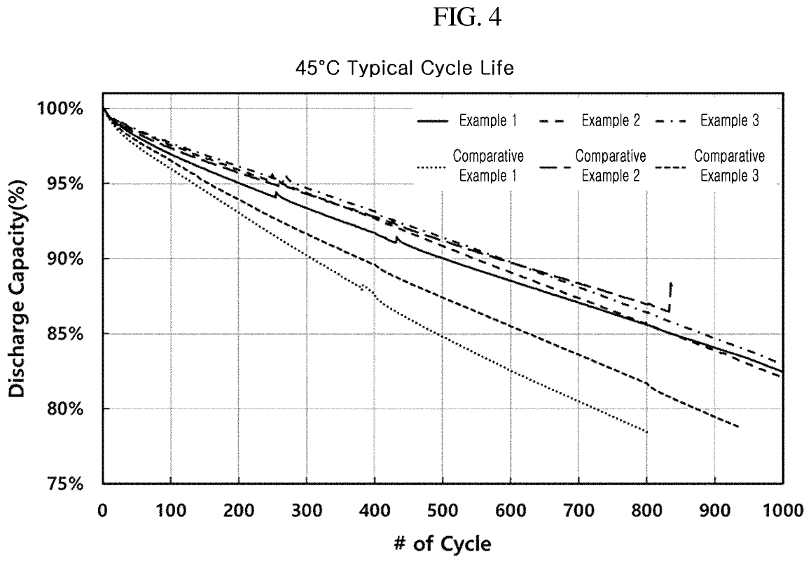

FIG. 4 is a graph showing the capacity retention as a function of the number of cycles at 45° C. for the batteries of the examples and comparative examples.

### Experimental Example 2: Evaluation of High-Temperature Storage Characteristics

The batteries of the examples and comparative examples were charged CC-CV 0.3C 4.2 V 0.05C cut-off) at 25° C., and in this state, stored at 60° C. for 20 weeks, with the discharge capacity measured at 4-week intervals. The capacity retention was calculated by dividing the discharge capacity at the 20th week by the initial discharge capacity.

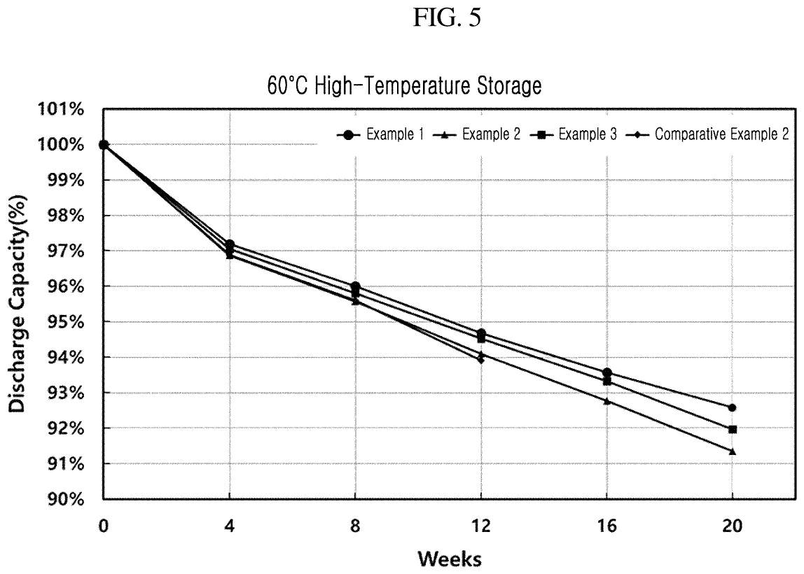

FIG. 5 is a graph showing the capacity retention as a function of time at 60° C. for the batteries of the examples and Comparative Example 2.

### Experimental Example 3: Evaluation of Fast Charge Cycle Life Characteristics

The lithium secondary batteries of the examples and comparative examples were subjected to repeated charging from SOC 10% to SOC 80% at C-rates of 2.75C, 2.5C, 2.25C, 2.0C, 1.75C, 1.5C, 1.25C, and 1.0C so that the target SOC was reached within 20 minutes at 25° C., followed by discharging at 0.3C. This was repeated for 300 cycles. The discharge capacity was measured according to the number of cycles, and the capacity retention was calculated by dividing the discharge capacities at the 150th and 300th cycles by the initial discharge capacity.

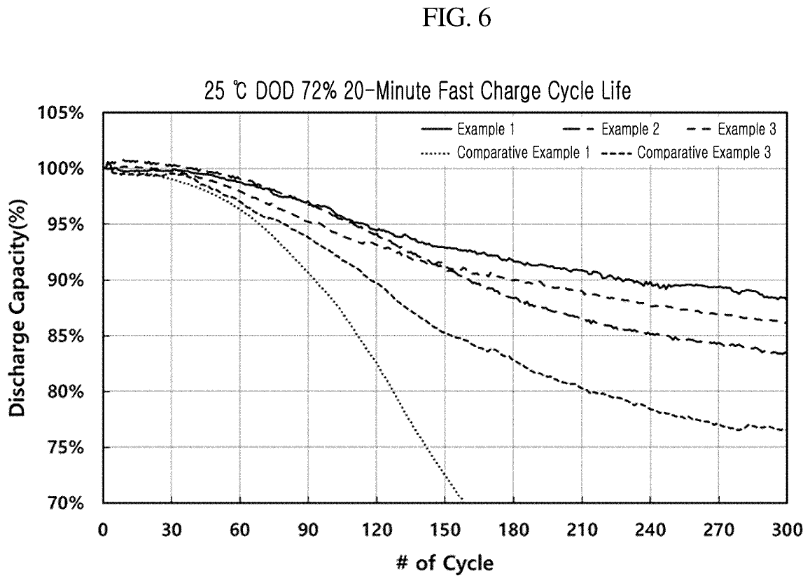

FIG. 6 is a graph showing the capacity retention according to the number of cycles at 25° C. for the batteries of the examples and comparative examples.

TABLE 2

| | | | | High- | | |
|---|---|---|---|---|---|---|
| | | | | temperature | | |
| | High-temperature cycle life | | | storage | Fast charge cycle life | |
| | characteristics (%) | | | characteristics | characteristics (%) | |
| | 800 cycles | 900 cycles | 1000 cycles | (%) | 150 cycles | 300 cycles |
| Example 1 | 85.6 | 84.1 | 82.5 | 76.2 | 92.9 | 88.2 |
| Example 2 | 85.7 | 83.9 | 82.1 | 74.6 | 90.9 | 83.4 |
| Example 3 | 86.4 | 84.7 | 82.9 | 75.1 | 91.3 | 86.2 |
| Comparative | 78.5 | Not | Not | Not measured | 72.5 | Sharp drop |
| Example 1 | | measured | measured | | | |
| Comparative | 87.0 | | Vent at 834 | Vent at 14 | Not | Not |
| Example 2 | | | cycles | weeks | measured | measured |
| Comparative | 81.7 | 79.4 | Not | Not measured | 85.3 | 76.6 |
| Example 3 | | | measured | | | |

Referring to Table 2 and FIGS. 4 to 6, the batteries of the examples exhibited a high capacity retention of 80% or more after 1,000 charge and discharge cycles at 45° C., and a capacity retention of 83% or more after 300 fast charge and discharge cycles. In addition, in the batteries of the examples, no venting occurred and high capacity was maintained even when stored for an extended period at 60° C.

On the other hand, the batteries of the comparative examples exhibited a sharp drop in capacity retention after about 800 charge and discharge cycles at 45° C., and the capacity retention dropped sharply after about 150 fast charge and discharge cycles, thereby degrading cycle life characteristics. In addition, the battery of Comparative Example 2 exhibited deteriorated high-temperature storage characteristics, with venting occurring after 14 weeks of storage at 60° C.

The contents described above are merely examples of applying the principles of the present disclosure, and other configurations may be further included without departing from the scope of the present disclosure.

### DESCRIPTION OF REFERENCE NUMERALS

100: Cathode
105: Cathode current collector
107: Cathode lead
110: Cathode active material layer
111: First cathode active material layer
112: Second cathode active material layer
120: Anode active material layer
125: Anode current collector
127: Anode lead
130: Anode
140: Separation membrane
150: Electrode assembly
160: Case

What is claimed is:

1. A cathode for a lithium secondary battery comprising:
a cathode current collector, and
a first cathode active material layer and a second cathode active material layer sequentially stacked on one surface of the cathode current collector,
wherein the first cathode active material layer comprises a first conductive material and either a mixture of a first cathode active material having a single-particle structure and a second cathode active material having a secondary-particle structure, or the second cathode active material,
wherein the second cathode active material layer comprises a second conductive material and either the first cathode active material, or a mixture of the first cathode active material and the second cathode active material,
wherein the content of the first cathode active material, based on the total weight of the first cathode active material layer, is less than the content of the second cathode active material,
wherein the content of the second cathode active material, based on the total weight of the second cathode active material layer, is less than or equal to the content of the first cathode active material, and
wherein the content of the first conductive material, based on the total weight of the first cathode active material layer, is less than the content of the second conductive material, based on the total weight of the second cathode active material layer.

2. The cathode for a lithium secondary battery according to claim 1, wherein the content of the first cathode active material, based on the total weight of the first cathode active material layer, is less than 50% by weight, and the content of the second cathode active material, based on the total weight of the first cathode active material layer, is 50% by weight to 99% by weight.

3. The cathode for a lithium secondary battery according to claim 1, wherein the content of the second cathode active material, based on the total weight of the first cathode active material layer, is 70% by weight to 99% by weight.

4. The cathode for a lithium secondary battery according to claim 1, wherein the content of the first cathode active material, based on the total weight of the first cathode active material layer, is less than 25% by weight.

5. The cathode for a lithium secondary battery according to claim 1, wherein the content of the first cathode active material, based on the total weight of the second cathode active material layer, is 50% by weight to 99% by weight, and the content of the second cathode active material, based on the total weight of the second cathode active material layer, is less than 50% by weight.

6. The cathode for a lithium secondary battery according to claim 1, wherein the content of the first cathode active material, based on the total weight of the second cathode active material layer, is 70% by weight to 99% by weight.

7. The cathode for a lithium secondary battery according to claim 1, wherein the content of the second cathode active material, based on the total weight of the second cathode active material layer, is less than 25% by weight.

8. The cathode for a lithium secondary battery according to claim 1, wherein the content of the first conductive material, based on the total weight of the first cathode active material layer, is 0.1% by weight to 0.8% by weight.

9. The cathode for a lithium secondary battery according to claim 1, wherein the content of the second conductive material, based on the total weight of the second cathode active material layer, is 0.5% by weight to 1.5% by weight.

10. The cathode for a lithium secondary battery according to claim 1, wherein the ratio of the content of the second conductive material, based on the total weight of the second cathode active material layer, to the content of the first conductive material, based on the total weight of the first cathode active material layer, is greater than 1 and less than or equal to 1.6.

11. The cathode for a lithium secondary battery according to claim 1, wherein the first conductive material and the second conductive material each independently comprise at least one selected from the group consisting of single-walled carbon nanotubes (SWCNTs), multi-walled carbon nanotubes (MWCNTs), and carbon black.

12. The cathode for a lithium secondary battery according to claim 1, wherein the first cathode active material and the second cathode active material each independently comprise a lithium metal oxide having a nickel content of 80 mol % to 99 mol % based on the total molar amount of elements excluding lithium and oxygen.

13. The cathode for a lithium secondary battery according to claim 1, wherein the first cathode active material and the second cathode active material are lithium metal oxides having different metal compositions.

14. The cathode for a lithium secondary battery according to claim 1, the first cathode active material includes a lithium metal oxide having a nickel content of 80 mol % to 99 mol % based on the total molar amount of elements excluding lithium and oxygen, and the second cathode active material includes a lithium metal oxide having a nickel content different from that of the first cathode active material.

15. A lithium secondary battery comprising:
the cathode for a lithium secondary battery according to claim 1; and
an anode disposed to face the cathode.
